(19) United States
(12) Patent Application Publication
(10) Pub. No.: US 2015/0110627 A1
(43) Pub. Date: Apr. 23, 2015

(54) BLADE BUCKET STRUCTURE FOR SAVONIUS TURBINE

(71) Applicant: Industry-University Cooperation Foundation Sunmoon University, Asan-si (KR)

(72) Inventor: Jae-Won KIM, Cheonan-si (KR)

(21) Appl. No.: 14/334,173

(22) Filed: Jul. 17, 2014

(30) Foreign Application Priority Data
Oct. 17, 2013 (KR) 10-2013-0124201

(51) Int. Cl. F03D 3/06; F03D 3/00

(52) U.S. Cl. CPC F03D 3/061; F03D 3/005
USPC 416/197 A

(57) ABSTRACT

Disclosed herein is a blade bucket structure for Savonius turbines. In the blade bucket structure, blade buckets on which resistance resulting from the flow of fluid occurs, are provided with a separated flow retardation means for reducing pressure drag force impeding rotation of a Savonius turbine. The separated flow retardation means can reduce resistance that acts in a direction opposite to the direction of rotation of the Savonius turbine because of variation in orientation of the blade buckets while rotating.

### CROSS REFERENCE TO RELATED APPLICATION

This application claims the benefit of Korean Patent Application No. 10-2013-0124201, filed on Oct. 17, 2013, which is hereby incorporated by reference in its entirety into this application.

### BACKGROUND OF THE INVENTION

1. Technical Field

The present invention relates generally to blade buckets for Savonius turbines and, more particularly, to a blade bucket structure for Savonius turbines in which blade buckets, on which resistance resulting from the flow of fluid occurs are provided with a separated flow retardation means for reducing pressure drag force impeding rotation of a Savonius turbine, thereby reducing resistance that acts in a direction opposite to the direction of rotation of the Savonius turbine because of variation in orientation of the blade buckets while rotating.

2. Description of the Related Art

Generally, wind power generation systems are classified into horizontal axis wind power generation systems and vertical axis wind power generation systems.

The horizontal axis wind power generation systems include propeller blades and are operated using lift force of the wind. Since the speed of revolution of the propeller blades is relatively high, the efficiency of power generation is also comparatively high. However, the orientation of the rotating blades must be changed depending on the direction of the wind, and the angle of the rotating blades must be changed depending on the wind speed. Given this, the horizontal axis wind power generation systems need to have complex adjustment mechanisms.

On the other hand, although the vertical axis wind power generation systems are low in generation efficiency, they have advantages in that a comparatively large torque can be obtained even under conditions of a relatively low wind speed, and output power is not dependent upon the direction of the wind. Thus, the vertical axis wind power generation systems are widely used as small wind power generation systems.

Darrieus blades and Savonius blades are widely used in the vertical axis wind generation systems.

Darrieus blades, using lift force of the wind, require an auxiliary power unit because they themselves cannot start to rotate.

Meanwhile, although the Savonius blades are disadvantageous in that the speed of revolution cannot be higher than the wind speed because of drag force of the wind applied to the blades, the Savonius blades can obtain a relatively large torque even under conditions of a comparatively low wind speed and start to rotate by themselves. Therefore, the Savonius blades are mainly used as small wind power generation systems.

Such a Savonius turbine belongs to the vertical axis system, and a blade of the turbine generally has an S shape. The speed of revolution of the Savonius turbine is relatively low, because a portion of the blade that is not applying rotating force to the turbine rather generates resistance to the wind while the turbine is rotating. However, the blade has a comparatively large surface area and faces the wind, and therefore there is an advantage in that a large torque can be produced.

Furthermore, the Savonius turbine is advantageous in that the efficiency of power generation is relatively high even under conditions of low wind speed and volume.

A representative type of a vertical axis small wind power generator is a Savonius rotor type in which two half pipes are disposed in opposite directions and configured such that when either of the half pipes receives the maximum drag force, the other half pipe receives the minimum drag force, thereby having characteristics of being periodical and generating large torque despite at a low tip speed ratio.

Various techniques, from using the conventional half pipe type to having recent spiral Savonius shape, and thereby taking noise and vibration into account, have been introduced for such Savonius rotors.

However, in conventional Savonius blades, when they rotate, a lot of noise and vibration occur on outer edges of the blades, thus reducing the output torque and discharge capacity, thereby reducing overall efficiency. Given this, a spiral Savonius blade was proposed, but it too, could not completely the above problem.

A representative prior art related to this was proposed in Korean Patent Unexamined Publication No. 2002-0005556 (Pub. Date: Jan. 17, 2002), entitled “Savonius windmill blade with air-vent groove.”

### SUMMARY OF THE INVENTION

Accordingly, the present invention has been made keeping in mind the above problems occurring in the prior art, and an object of the present invention is to provide a blade bucket structure for Savonius turbines in which a separated flow retardation means is formed in convex surfaces of blade buckets, thus reducing pressure drag force, which is applied to the blade buckets in a direction opposite to a direction of rotation of the blade bucket by fluid colliding with the convex surfaces of the blade buckets when the blade bucket of a Savonius turbine rotates, thereby enhancing the efficiency of the Savonius turbine.

Particularly, the object of the present invention can be achieved with a simple structure in which a plurality of dimples are formed as the separated flow retardation means in the convex surfaces of the blade buckets. Therefore, the present invention can provide a blade bucket structure which is simple and is able to enhance the efficiency of power generation.

In order to accomplish the above object, the present invention provides a blade bucket structure of a Savonius blade for a Savonius turbine, the blade bucket structure including: a rotating shaft provided in a central portion between a circular upper plate and a circular lower plate; a plurality of blade buckets extending from the rotating shaft in a circumferential direction of the upper and lower plates in such a way that the blade buckets are opposed to each other, the blade buckets have arc shapes curved in opposite directions; and a separated flow retardation means formed in a convex surface of each of the arc-shaped blade buckets, the separated flow retardation means reducing pressure drag force generated by fluid colliding with the corresponding surface.

The separated flow retardation means may include a plurality of dimples formed in the convex surface of each of the blade buckets at positions spaced apart from each other.

Each of the dimples may have a semicircular shape that is concave in a direction opposite to a direction in which the blade bucket is concave.

The blade bucket may have a diameter larger than a radius of the upper or lower plate.

An edge of each of the blade buckets that is adjacent to the rotating shaft may pass over the rotating shaft and extend towards the facing blade bucket.

As described above, in a Savonius turbine which rotates using resistance pressure of fluid applied to concave surfaces of blade buckets, a blade bucket structure according to the present invention can reduce pressure drag force which is applied to the blade buckets in a direction opposite to a direction of rotation of the blade buckets by fluid colliding with convex surfaces of the blade buckets, thereby enhancing the efficiency of the Savonius turbine.

Furthermore, a separated flow retardation means for achieving the above effects has a simple structure so that manufacture of the Savonius turbine can be facilitated, and an increase in production cost can be prevented.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a blade bucket structure according to the present invention;

FIG. 2 is a view illustrating a blade bucket having dimples according to the present invention;

FIG. 3 is a view showing drag force applied to dimpleless blade buckets; and

FIG. 4 is a view showing drag force applied to blade buckets having dimples.

### DESCRIPTION OF THE PREFERRED EMBODIMENTS

The present invention will be described in detail below with reference to the accompanying drawings.

In the following description, redundant descriptions and detailed descriptions of known functions and elements that may unnecessarily make the gist of the present invention obscure will be omitted.

Embodiments of the present invention are provided to fully describe the present invention to those having ordinary knowledge in the art to which the present invention pertains.

Accordingly, in the drawings, the shapes and sizes of elements may be exaggerated for the sake of clearer description.

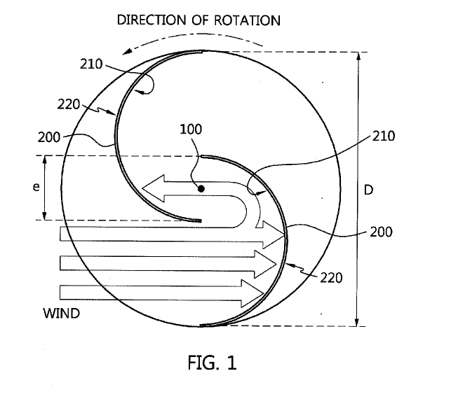

FIG. 1 is a view illustrating a blade bucket structure according to the present invention.

The blade bucket structure related to a Savonius blade according to the present invention will be described with reference to FIG. 1. The blade bucket structure includes a rotating shaft 100, a plurality of blade buckets 200 and a separated flow retardation means. The rotating shaft 100 is provided in a central portion between a circular upper plate (not shown) and a circular lower plate (not shown). The blade buckets 200 extend from the rotating shaft 100 in a circumferential direction of the upper and lower plates in such a way that the blade buckets 200 are opposed to each other. The blade buckets 200 have arc shapes, which are curved in opposite directions. The separated flow retardation means is formed in a convex surface 220 of each arc-shaped blade bucket 200 so as to reduce pressure drag force generated by fluid colliding with the corresponding surface.

The upper plate and the lower plate are provided at positions spaced apart from each other. The rotating shaft 100 is disposed in a central portion between the upper and lower plates.

Extending from the rotating shaft 100 outwards, that is, towards outer circumferential edges of the upper and lower plates, each blade bucket 200 has a radially curved shape and includes a concave surface 210 and the convex surface 220.

Upper and lower ends of each blade bucket 200 respectively make contact with the upper and lower plates in the same manner as that o the rotating shaft 100.

As shown in FIG. 1, each blade bucket 200 has the concave surface 210 on one side thereof, and the convex surface 220 is formed on the other side of the blade bucket 200 that is opposite to the concave surface 210. The blade bucket 200 has a semicircular arc shape.

Particularly, in the present invention, the blade bucket 200 is configured such that a linear distance between an inner edge of the blade bucket 200 that is adjacent to the rotating shaft 100 and an outer edge of the blade bucket 200 that is adjacent to the outer circumferential edges of the upper and lower plates is longer than the radius of the upper or lower plate. For example, if the blade bucket 200 has a semicircular arc shape, the linear distance that corresponds to the diameter of the semicircle defined by the blade bucket 200 is greater than the radius of the upper or lower plate.

Here, the outer edge of each blade bucket 200 does not protrude outwards from the outer circumferential edge of the upper or lower plate. Preferably, the outer edge of the blade bucket 200 is tangent to the outer circumferential edges of the upper and lower plates. The inner edge of each blade bucket 200 passes over the rotating shaft 100 and extends to a position adjacent to the center of the other blade bucket that is opposite to the corresponding blade bucket 200 based on the rotating shaft 100.

In the two blade buckets 200 that face each other, having the above-mentioned shape, as shown in FIG. 1, fluid applied to the corresponding blade bucket 200 flows through the rotating shaft 100 to the blade bucket 200, the convex surface 220 of which faces fluid flowing in one direction, while overcoming resistance pressure of fluid. Thereby, pressure that can continuously rotate the blade buckets 200 is applied to the blade buckets 200.

Having the above-mentioned structure, the blade bucket 200 according to the present invention is also technically characterized in that the separated flow retardation means formed on the concave surface 210 of the blade bucket 200 reduces resistance pressure generated on the convex surface 220 of the blade bucket 200, thus enhancing the efficiency of a Savonius turbine.

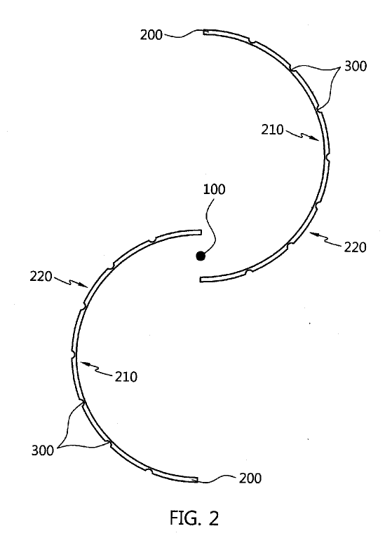

FIG. 2 is a view illustrating blade buckets 200 having dimples 300 therein according to the present invention.

The separated flow retardation means includes the dimples 300 which are formed in the convex surface 220 of each blade bucket 200 at positions spaced apart from each other.

Formed in the convex surface 220 of each blade bucket 200, the dimples 300 each have a semicircular shape, which is concave in a direction opposite to that of the blade bucket 200.

The dimples 300 generate turbulent flow, when fluid collides with, and retard the time of separation flow of fluid, which is separated along an inclined surface of the convex surface 220 because of the shape of the convex surface 220 of the blade bucket 200 when the fluid collides with the convex surface 220. Thereby, pressure resistance resulting from fluid applied to the convex surface 220 of the blade bucket 200 can be reduced.

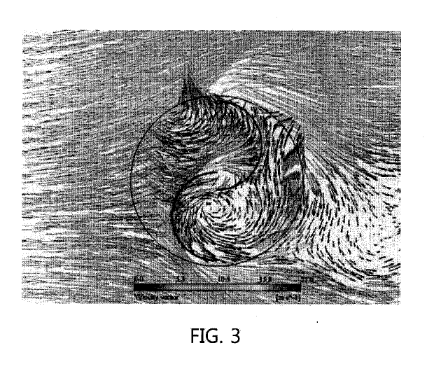

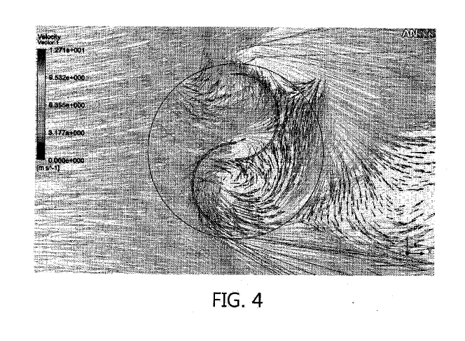

FIG. 3 is a view showing drag force applied to dimpleless blade buckets 200. FIG. 4 is a view showing drag force applied to blade buckets 200 having dimples.

Comparing FIGS. 3 and 4 to each other, a range of a vortex formed in the blade buckets 200 having the dimples 300 is markedly less than that in the dimpleless blade buckets 200. A range of influence due to the vortex is also limited to the vicinity of the rotating shaft 100 which is disposed at the center of the blade bucket structure.

The magnitude of reverse pressure, which is applied to the convex surface 220 of the blade bucket 200 and has a negative effect on rotation of the Savonius turbine that is rotated by means of pressure applied to the concave surface 210 of the blade bucket 200, is proportional to the magnitude of the vortex. Given this, it can be understood that, with regard to improving the power of the Savonius turbine, the efficiency of the blade buckets 200 having the dimples 300 according to the present invention is higher than that of the dimpleless blade buckets.

Along with the tests of FIGS. 3 and 4, tests of generating electricity from wind energy respectively using the dimpleless blade buckets 200 and the blade bucket structure having the dimples 300 for Savonius turbines according to the present invention were conducted. The results are as Table 1.

TABLE 1

| | Dimpleless blade | Blade bucket (200) |
|---|---|---|
| | bucket (200) | having dimples (300) |
| Diameter of turbine | 0.165 m | |
| Velocity of air | 6 m/sec | |
| Initial phase of blade | 11 o’clock | |
| bucket (200) having | | |
| concave surface (210) | | |
| facing wind | | |
| Power coefficient, Cp | 0.197 | 0.21 |
| (power/[dynamic pressure × | | |
| flow rate]) | | |
| Rate of increase in power | — | 6.6% |

Table 1 shows the results of the tests conducted under conditions in which: room temperature fluid (air) is supplied to the Savonius turbine at a constant velocity of 6 m/s; the diameter of the turbine that corresponds to the diameter of the upper and lower plates is 0.165 m; and of the two blade buckets 200, the phase of the blade bucket 200, the concave surface 210 of which faces fluid flowing in one direction, is 11 o'clock.

The power coefficient was 0.197 in the dimpleless blade bucket and 0.21 in the blade bucket having dimples 300 according to the present invention. As such, reducing pressure resistance applied to the concave surface 210 of the blade bucket 200, the dimples 300 increased the power by 6.6%.

As described above, the blade bucket structure for the Savonius turbine according to the present invention, despite having a simple structure, can markedly reduce pressure resistance applied to the concave surfaces 210 of the blade buckets 200.

As a result, the efficiency of the Savonius turbine can be enhanced. Thanks to the simple structure, the production cost is relatively low, and the production can be facilitated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A blade bucket structure of a Savonius blade for a Savonius turbine, the blade bucket structure comprising:
a rotating shaft provided in a central portion between a circular upper plate and a circular lower plate;
a plurality of blade buckets extending from the rotating shaft in a circumferential direction of the upper and lower plates in such a way that the blade buckets are opposed to each other, the blade buckets have arc shapes curved in opposite directions; and
a separated flow retardation means formed in a convex surface of each of the arc-shaped blade buckets, the separated flow retardation means reducing pressure drag force generated by fluid colliding with the corresponding surface.

2. The blade bucket structure as set forth in claim 1, wherein the separated flow retardation means comprises a plurality of dimples formed in the convex surface of each of the blade buckets at positions spaced apart from each other.

3. The blade bucket structure as set forth in claim 2, wherein each of the dimples has a semicircular shape that is concave in a direction opposite to a direction in which the blade bucket is concave.

4. The blade bucket structure as set forth in claim 1, wherein the blade bucket has a diameter larger than a radius of the upper or lower plate.

5. The blade bucket structure as set forth in claim 4, wherein an edge of each of the blade buckets that is adjacent to the rotating shaft passes over the rotating shaft and extends towards the facing blade bucket.
